(19) United States
(12) Patent Application Publication
(10) Pub. No.: US 2006/0160418 A1
(43) Pub. Date: Jul. 20, 2006

(54) Controlling conductor displacement in connectors with an inner conductor

(75) Inventors: Steven O. Fournier, Southington, CT (US); William P. Mazza, Milford, CT (US); Robert J. Wallick, Windsor, CT (US); Robert D. Godburn JR., Waterbury, CT (US)

Correspondence Address: ROTHWELL, FIGG, ERNST & MANBECK, P.C., 1425 K STREET, N.W., SUITE 800, WASHINGTON, DC, 20005, US

(73) Assignee: Litton Systems, Inc.

(21) Appl. No.: 11/035,070

(22) Filed: Jan. 14, 2005

(51) Int. Cl. H01R 9/05

(52) U.S. Cl. 439/579

(57) ABSTRACT

In one aspect, the present invention provides an electrical connector having a center conductor and means for preventing displacement of the center conductor, which displacement typically occurs in conventional connectors when the connector is heated and then cooled.

### BACKGROUND OF THE INVENTION

1. Field of the Invention

The present invention relates to electrical connectors. In some aspects, the present invention relates to electrical connectors having an inner or “center” conductor (i.e., a conductor surrounded by a dielectric and housed within a connector housing).

2. Discussion of the Background

In conventional electrical connectors having a center conductor, a dielectric (e.g., a polymer or other dielectric) mechanically supports the center conductor within a connector housing. A challenge to designers is how to design the connector to maintain critical interface dimensions and conductor path integrity during printed-circuit-board (PCB) wave solder and reflow, where temperatures can exceed 260 degrees Celsius.

During this extreme heating that occurs during the process of connecting the connector to a printed-circuit-board (PCB), both the dielectric and connector housing expand. However, the dielectric typically expands at a rate significantly greater than the housing resulting in applied mechanical stresses on the conductor as well as changes in the final location of a contact socket interface after heating. The goal of any designer is to mitigate applied mechanical forces during the high temperature excursion and to hold within tolerance all critical contact and interface dimensions.

As a specific example, consider an electrical connector having a brass housing, a Teflon® member housed within the brass housing, and a center conductor supported and surrounded by the Teflon member. The coefficient of thermal expansion (CTE) of Teflon is 122 μin/° F. and that of C160 brass is 11.1 μin/° F. Since the CTE of Teflon in the temperature range to which the connector will be subjected is an order of magnitude greater than that of the brass body that encapsulate it, there is a danger that the stresses induced by the expanding and contracting Teflon member will move the center conductor out of the desired position (i.e., displace the center conductor).

In fact, after temperature cycling, the center conductor may translate toward the front of the connector resulting in a significant dimensional change at the mating interface (about 0.020 in). This shifting of the contact also appears to generate stresses on the solder joint, which can cause the rear contact, which is normally perpendicular to the plane of the PC board, to lean at an angle of between 1 and 1.5° of normal.

The conductor displacement problem is exacerbated when lead-free solder is used as PCB connection means because using lead-free solder requires exposing the connector to a higher temperature during the solder reflow process, and exposing the connector to a higher temperature causes greater expansion of the dielectric member, which leads to a more noticeable displacement of the inner conductor.

What is desired, therefore, is an electrical connector that does not suffer the above-described conductor displacement problem.

### SUMMARY OF THE INVENTION

It was discovered that the above described conductor displacement problem is particularly noticeable when an end of the dielectric body abuts a wall during assembly and the heating process. When subjected to high heat, the dielectric body moves away from this immovable surface, taking the center contact with it. As the connector cools, the dielectric body contracts symmetrically. The net affect is a translation of the center contact away from the wall equal to one-half the axial expansion of the dielectric body, and an air gap between the wall and the end of the body also equal to one-half the axial expansion of the body.

Accordingly, the present invention provides an electrical connector having a center conductor and means for helping prevent displacement of the center conductor during a solder reflow process.

In one embodiment, instead of positioning the dielectric body so that its end abuts the wall, the body is positioned so that a gap exists between the wall and the end of the body.

In the same or another embodiment, a securing means for securing the dielectric body within the housing is used. The securing means may include a rib projecting outwardly from the dielectric body and a corresponding groove in the housing for receiving the rib. The securing means may also include one or more fasteners.

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, help illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a cross-sectional, side view of a connector according to an embodiment of the invention.

FIG. 2 is a cross-sectional, side view of a connector according to another embodiment of the invention.

FIGS. 3 and 4 are cross-sectional, side views of a connector according to another embodiment of the invention.

FIG. 5 is a flow chart illustrating a process according to an embodiment of the invention.

### DETAILED DESCRIPTION OF PREFERRED EMBODIMENTS

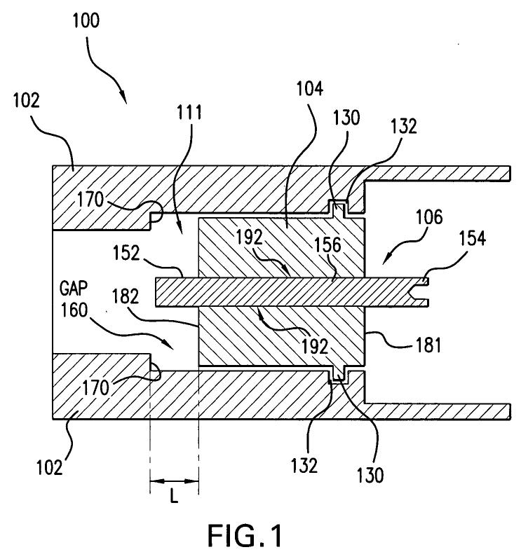

Referring now to FIG. 1, FIG. 1 is a cross-sectional, side view of a connector according to an embodiment of the invention. As shown in FIG. 1, connector 100 includes a housing 102 having a cavity 111 and a dielectric body 104 and a conductor or “contact” 106 housed in cavity 111 of housing 102. More specifically, dielectric body 104 supports and electrically insulates conductor 106 from housing 102. Housing 102 and conductor 106 may be made from brass and/or other electrically conducting material, and dielectric body 104 may comprise Teflon® and/or other dielectric materials.

As further shown in FIG. 1, conductor 106 has a first end section 152, a second end section 154 and an interim section 156. Interim section 156 of conductor 106 is embedded within dielectric body 104, while end sections 152 and 154 are not disposed within dielectric body 104.

As further shown in FIG. 1, connector 100 includes features that when used together or alone help prevent conductor 106 from being displaced during heating and subsequent cooling of connector 102. For example, dielectric body 104 has a male member 130 projecting from a top surface thereof (male member 130 is referred to herein as “rib 130”) and body 102 has a corresponding female groove 132 for receiving rib 130. Rib 130 may be machined into dielectric body 104 or otherwise attached thereto. Groove 132 is formed in the inner surface of housing 102. In this embodiment, the location of rib 130 on dielectric body 104 is preferably at or near a first end 181 of dielectric body 104. Rib 130 and groove 132 function to secure body 104 within cavity 111.

During assembly, dielectric body 104 is positioned such that rib 130 is located securely in groove 132. Preferably, dielectric body 104 is positioned such that a gap 160 exists between a second end 182 of dielectric body 104 and a wall 170 of housing 102 that faces the second end 182 of dielectric body 104. Wall 170 projects inwardly from the inner surface of housing 102. Preferably, wall 170 is generally perpendicular to the inner surface of housing 102. The length (L) of gap 160 is preferably about equal to or greater than the total amount of expected longitudinal expansion of dielectric body 104. The expected longitudinal expansion of dielectric body 104 (“delta-L”) can be calculated using the following formula:
delta−L=(CTE)(T2−T1)(Lᵢ),
where CTE is a known constant, T2 is the temperature at which the dielectric will be heated, T1 is the temperature of the dielectric prior to heating (e.g., room temperature) and Lᵢ is the length of the dielectric at temperature T1.

As connector 100 is heated, rib 130 provides a “pivot point.” That is, rib 130 provides a means for retaining the expanding dielectric body 104 and affecting the direction of the expansion of the dielectric body 104. For example, rib 130 forces dielectric body 104 to expand longitudinally into gap 160, since most of the expanding mass of dielectric body 104 is located between gap 160 and rib 130. Further, as dielectric body 104 cools, rib 130 provides a point around which dielectric body 104 contracts, allowing dielectric body 104 and the embedded conductor 106 to return, as nearly as possible, to their initial position. In this manner, conductor 106 will not be displaced due to the expansion and contraction of body 104 due to the heating and subsequent cooling of connector 100.

As shown in FIG. 1, interim section 156 of conductor 106 may have a retention barb 192 on a surface thereof, which barb 192 functions to limit longitudinal movement of conductor in a direction away from wall 170.

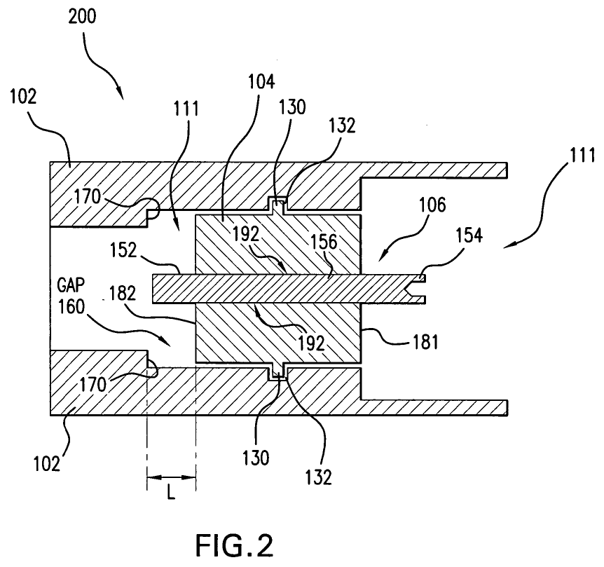

Referring now to FIG. 2, FIG. 2 is a cross-sectional, side view of a connector 200 according to another embodiment of the invention. In the embodiment shown in FIG. 2, rib 130 is located generally midway between ends 181 and 182.

Preferably, contact 106 is designed such that when contact 106 is fully seated, retention barb 192 is concentric to the rib 130; i.e., barb 192 is in the same longitudinal position as rib 130 at assembly. The design intent is to affix dielectric body 104 such that, even during heating and cooling, it maintains its longitudinal position in the body. Expansion and contraction are allowed to take place symmetrically about rib 130 thus insuring that contact 106 undergoes no translations that might induce stress to the solder joint or otherwise affect the reference (mating) surfaces.

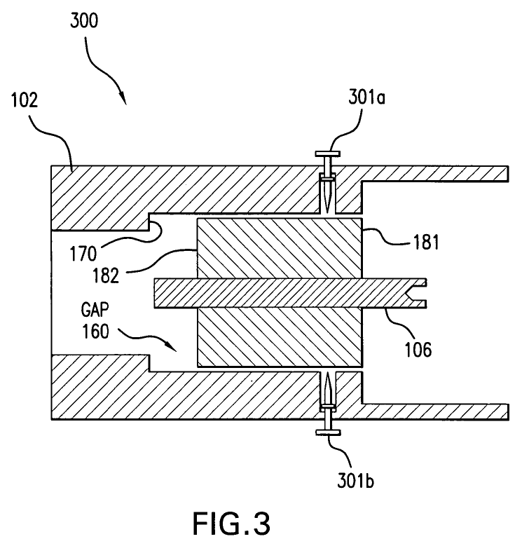

Referring now to FIG. 3, FIG. 3 is a cross-sectional, side view of a connector 300 according to another embodiment of the invention. Connector 300 is similar to connectors 200 and 100, with an exception that rib(s) 130 and groove(s) 132 are replaced with fasteners 301a and 301b. In the embodiment shown, fasteners 301 are both placed at or near end 181 of dielectric body 104. However, it is contemplated that, like the connector shown in FIG. 2, fasteners 301 may be located at a point midway between ends 181 and 182 of body 104. Fasteners 301 provide the same functionality as the rib and groove combination. That is, fasteners help prevent conductor 106 from moving out of its initial position when body 104 expands and contracts due to heating and then subsequent cooling. Like ribs 130 and grooves 132, fasteners 301 provide the “pivot point” functionality described above.

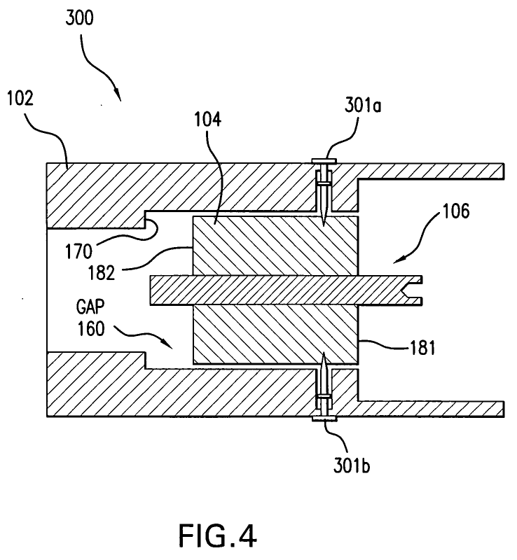

Preferably, fasteners 301 are moveable from a first position to a second position. Placing fasteners 301 in the first position, which position is illustrated in FIG. 3, facilitates positioning body 104 within cavity 111 of housing 102. Placing fasteners 301 in the second position, which position is illustrated in FIG. 4, facilitates fastening body 104 within cavity 111 of housing 102. As illustrated in FIG. 4, fasteners 301 may be in the shape of a pin and may penetrate body 104 when moved from the first position to the second position. While only two fasteners 301 are shown, a housing 102 have more than two fasteners 301 is contemplated.

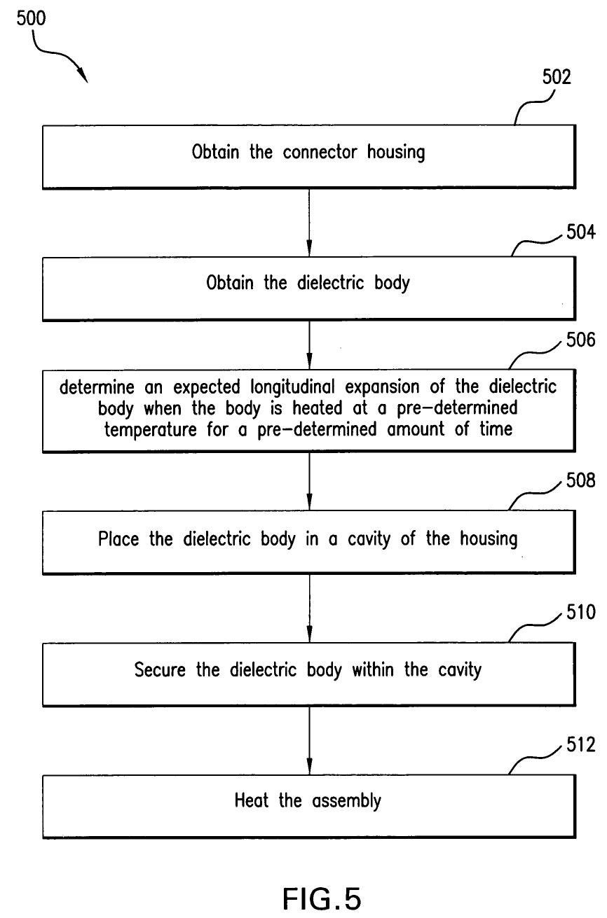

Referring now to FIG. 5, FIG. 5 is a flow chart illustrating a process 500 according to an embodiment of the invention. Process 500 may begin in step 502, where a connector housing, like housing 102, is obtained. In step 504, a dielectric body is obtained (e.g., dielectric body 104). The dielectric body surrounds an interim portion of a contact (e.g., contact 106).

In step 506, an expected longitudinal expansion of the dielectric body when the body is heated at a pre-determined temperature for a pre-determined amount of time is determined. The pre-determined temperature generally ranges between 150 and 300 degrees Celsius and the pre-determined amount of time generally ranges between ten seconds and ten minutes.

In step 508, dielectric body 104, which houses the contact 106, is placed in cavity 111 formed by a wall or walls of housing 102. As discussed above, body 104 may be positioned in cavity 111 so that a gap 160 exists between end 182 and wall 170. Preferably, the length (L) of gap 160 is about equal to or greater than the determined expected longitudinal expansion of body 104.

In step 510, dielectric body 104 is secured within cavity 111. Body 104 may be secured by fitting rib 130 into groove 132, as shown in FIGS. 1 and 2 or by moving fasteners 301 from the first position to the second position, as described above with respect to FIGS. 3 and 4.

In step 512, the assembly is heated at a temperature between about 150 and 300 degrees Celsius for an amount of time between about ten seconds and ten minutes.

While various embodiments/variations of the present invention have been described above, it should be understood that they have been presented by way of example only, and not limitation. For example, depending on the specific requirements of a particular connector design, features of one or both of the above described embodiments may be employed to null the affects of dielectric expansion/shrinkage during heating.

Thus, the breadth and scope of the present invention should not be limited by any of the above-described exemplary embodiments, but should be defined only in accordance with the following claims and their equivalents.

What is claimed is:

1. A connector, comprising:
a housing having an inner surface;
a dielectric body housed in the housing, the dielectric body having a first end and a second end;
a conductor having an interim section surrounded by the dielectric body, wherein
the dielectric body includes a rib positioned in a corresponding groove in the inner surface of the housing;
the housing includes a wall substantially facing the first end of the dielectric body; and
a gap exists between the wall and the first end of the dielectric body.

2. A method comprising the steps of assembling a connector as described in claim 1 and heating the assembled connector at a temperature great than about 200 degrees Celsius for at least about 5 minutes.

3. The connector of claim 1, wherein the housing is a substantially metallic housing.

4. The connector of claim 3, wherein the dielectric body comprises Teflon and the metallic housing consist essentially of brass.

5. The connector of claim 1, wherein the length of the gap is about greater than or equal to a total amount of expected longitudinal expansion of the dielectric body.

6. A method for assembling an electrical connector, comprising:
obtaining a housing;
obtaining a dielectric body having an end;
obtaining a conductor having an interim portion between two end portions, the interim section being surrounded by the dielectric body;
determining an expected longitudinal expansion of the dielectric body when the body is heated at a pre-determined temperature for a pre-determined amount of time;
placing the dielectric body into a cavity of the housing so that there exists a gap between the end of the dielectric body and a projection projecting inwardly from an inner surface of the housing, wherein
the length of the gap is about equal to or greater than the determined expected longitudinal expansion of the dielectric body.

7. The method of claim 6, further comprising forming a rib projecting outwardly from a surface of the dielectric body.

8. The method of claim 7, further comprising forming a groove in the inner surface of the housing.

9. The method of claim 8, further comprising positioning the dielectric body in the housing so that the rib is inserted into the groove.

10. The method of claim 7, wherein the rib is positioned about midway between the first end of the dielectric body and a second end of the dielectric body.

11. The method of claim 7, wherein the rib is positioned at or near a second end of the dielectric body, wherein the second end is opposite the first end.

12. The method of claim 6, wherein after the dielectric body is placed in the cavity of the housing the resulting assembly is heated at a temperature of at least about 200 degrees Celsius for at least about 5 minutes.

13. The method of claim 6, further comprising securing the dielectric body within the cavity.
